(19) United States
(12) Patent Application Publication
(10) Pub. No.: US 2014/0379270 A1
(43) Pub. Date: Dec. 25, 2014

(54) SYSTEM AND METHOD FOR ALIGNING GENOME SEQUENCE CONSIDERING MISMATCH

(71) Applicant: SAMSUNG SDS CO., LTD., Seoul (KR)

(72) Inventor: Min Seo PARK, Seoul (KR)

(73) Assignee: SAMSUNG SDS CO., LTD., Seoul (KR)

(21) Appl. No.: 14/308,142

(22) Filed: Jun. 18, 2014

(30) Foreign Application Priority Data
Jun. 19, 2013 (KR) 10-2013-0070454

(51) Int. Cl. G06F 19/22

(52) U.S. Cl. CPC G06F 19/22
USPC 702/19

(57) ABSTRACT

A system and method for aligning a genome sequence considering mismatches are provided. The system for aligning a genome sequence includes an error bound calculation unit configured to calculate an error bound of a read according to a length of the input read, a comparison unit configured to calculate an error number estimate of the read and compare the error bound with the calculated error number estimate, and an alignment unit configured to perform a global alignment of the input read with a reference sequence when the comparison result shows that the calculated error number estimate is less than or equal to the error bound.

### CROSS-REFERENCE TO RELATED APPLICATION

This application claims priority to and the benefit of Korean Patent Application No. 2013-0070454, filed on Jun. 19, 2013, the disclosure of which is incorporated herein by reference in its entirety.

### BACKGROUND

1. Field

Exemplary embodiments of the present disclosure relates to technologies for aligning a genome sequence used to decode genetic information.

2. Discussion of Related Art

An algorithm for aligning a genome sequence refers to an algorithm for mapping a read produced in a sequencing machine (or a sequencer) configured to produce a genome sequence to a known reference sequence.

Alignment of a genome sequence between a reference sequence and a read sequence is basically based on the exact matching using the homology of the genome sequence. However, alignment methods permitting a certain level of errors (mismatches) necessarily require algorithms for aligning a genome sequence due to errors in a sequencing procedure, polymorphisms in genetic information of living organisms, and the like. Therefore, conventional algorithms for aligning a genome sequence are configured to permit the errors within a given range.

Meanwhile, the cost required to produce reads has decreased to half or less over the past with current development of next-generation sequencing techniques, and thus the lengths of reads produced with an increase in amount of available data have also been diversified. That is, the reads produced in each sequencer had different lengths, and reads (i.e., short sequences) having different lengths were produced only in one sequencer. Also, the lengths of the reads produced in the sequencers have gradually increased with development of the sequencers, and it is expected that the lengths of reads increase to 5,000 base pairs (bp) in the case of 3G sequencers which will be developed in the future. However, the conventional genome sequencing algorithms have problems in that the lengths of the reads to be output are diversified and an increase in the lengths is not reflected since the error bounds are mechanically applied according to the values (fixed values) set by sequencer manufacturers or users, but the error bounds are not variably applied in consideration of the properties of the reads to be produced.

### SUMMARY

Examples of the present disclosure are directed to a system and method for aligning a genome sequence considering mismatches capable of enhancing accuracy in analyzing a genome sequence by calculating an optimum error bound for each read according to properties of the read input from a sequencer.

According to an aspect of the present disclosure, there is provided a system for aligning a genome sequence, which includes an error bound calculation unit configured to calculate an error bound of a read according to a length of the input read, a comparison unit configured to calculate an error number estimate of the read and compare the error bound with the calculated error number estimate, and an alignment unit configured to perform a global alignment of the input read with a reference sequence when the comparison result shows that the calculated error number estimate is less than or equal to the error bound.

The error bound may be set to be in proportion to the length of the read.

The error bound may be calculated by the following Expression:

0<Error bound≦ceil(A×R_{length}+B)+K

wherein R_{length} represents a length of a read, A is a real number ranging from 0.02 to 0.05, B is a real number ranging from 2.2 to 2.6, K is a real number ranging from 0 to 2, and ceil (X) is the least one of integers greater than or equal to X.

The comparison unit may perform exact matching of the read with the reference sequence while moving from the first base of the read by at least one base. In this case, when the exact matching is difficult at a certain position of the read, the comparison unit may newly perform the exact matching while moving from the next base of the corresponding position by at least one base, and, when the last base of the read is reached, the comparison unit sets the number of the positions that the exact matching is determined to be difficult as an error number estimate of the read.

The comparison unit may discard the read when the comparison result shows that the calculated error number estimate is greater than the error bound.

According to another aspect of the present disclosure, there is provided a method of aligning a genome sequence. Here, the method includes calculating an error bound of a read at a calculation unit according to a length of the input read, calculating an error number estimate of the read at a comparison unit, comparing the error bound with the calculated error number estimate at the comparison unit, and performing a global alignment of the input read with the reference sequence at an alignment unit when the comparison result shows that the calculated error number estimate is less than or equal to the error bound.

The error bound may be set to be in proportion to the length of the read.

The error bound may be calculated by the following Expression:

0<Error bound≦ceil(A×R_{length}+B)+K

wherein R_{length} represents a length of a read, A is a real number ranging from 0.02 to 0.05, B is a real number ranging from 2.2 to 2.6, K is a real number ranging from 0 to 2, and ceil (X) is the least one of integers greater than or equal to X.

The calculating of the error number estimate may include performing exact matching of the read with the reference sequence while moving from the first base of the read by at least one base. In this case, when the exact matching is difficult at a certain position of the read, the exact matching may be newly performed while the comparison unit is moving from the next base of the corresponding position by at least one base, and, when the last base of the read is reached, the number of the positions that the exact matching is determined to be difficult may be set as an error number estimate of the read.

The comparing of the error bound with the calculated error number estimate may further include discarding the read when the comparison result shows that the calculated error number estimate is greater than the error bound.

### BRIEF DESCRIPTION OF THE DRAWINGS

The above and other objects, features and advantages of the present disclosure will become more apparent to those of ordinary skill in the art by describing in detail exemplary embodiments thereof with reference to the accompanying drawings, in which:

FIG. 1 is a block diagram showing a system 100 for aligning a genome sequence according to one exemplary embodiment of the present disclosure;

FIGS. 2A-2E are diagrams illustrating a process of calculating an mEB at a comparison unit 104 of the system 100 for aligning a genome sequence according to one exemplary embodiment of the present disclosure; and

FIG. 3 is a flowchart illustrating a method 300 of aligning a genome sequence according to one exemplary embodiment of the present disclosure.

### DETAILED DESCRIPTION OF EXEMPLARY EMBODIMENTS

Hereinafter, embodiments of the present disclosure will be described in detail with reference to the attached drawings. However, the embodiments of the present disclosure is merely an example and the present disclosure is not limited to the exemplary embodiments disclosed below.

When it is determined that the detailed description of known art related to the present disclosure may obscure the gist of the present disclosure, such detailed description will be omitted. The same reference numerals are used to refer to the same elements throughout the specification. Terminologies described below are defined considering functions in the present disclosure and may vary according to a user's or operator's intention or usual practice. Thus, the meanings of the terminology should be interpreted based on the overall context of the present specification.

Consequently, the technical spirit of the present disclosure is determined by the claims, and the following embodiments are merely a means of efficiently explaining technical concepts of the present disclosure to those skilled in the art to which the present disclosure pertains.

Prior to fully describing the exemplary embodiments of the present disclosure, the terms used in the present disclosure will be described, as follows. First, the term “read” refers to data on a genome sequence having a short length, which is output from a genome sequencer. The length of the read generally varies from 35 to 500 bp according to the kind of sequencers. In general, the DNA bases are represented by four alphabets; A, C, G, and T.

The term “reference sequence” refers to a genome sequence for reference used to produce the entire genome sequence from the reads. In the analysis of the genome sequence, the entire genome sequence is completed by mapping a large amount of reads output from a genome sequencer with reference to the reference sequence. In the present disclosure, the reference sequence may be a predetermined sequence (e.g., an entire human genome sequence, etc.) in the analysis of the genome sequence, or a genome sequence produced in the genome sequencer may be used as the reference sequence.

The term “bases” are the smallest units used to constitute a reference sequence and a read. As described above, the DNA bases may be represented by the four alphabets; A, C, G, and T, each of which is expressed as a base. That is, the DNA bases are expressed as four bases. In the case of the reads, the DNA bases are also expressed as four bases. In the case of the reference sequence, however, it may be unclear which one of the bases A, C, G, and T is expressed as a base in a certain position due to various reasons (i.e., sequencing errors, sampling errors, etc.). In general, this unclear base is expressed as a separate alphabet N.

The term “seed” is a sequence that is used as a unit sequence when a read is compared with a reference sequence to map the read. In theory, to map a read to the reference sequence, a mapping position of the read should be calculated while sequentially comparing the entire read with the reference sequence starting from the first base of the reference sequence. However, such a method requires lots of time and computing power to map one read. Thus, a seed that is a fragment constituting a portion of the read is first mapped to the reference sequence to point out a candidate mapping position of the entire read, and the entire read is then mapped in the corresponding candidate mapping position.

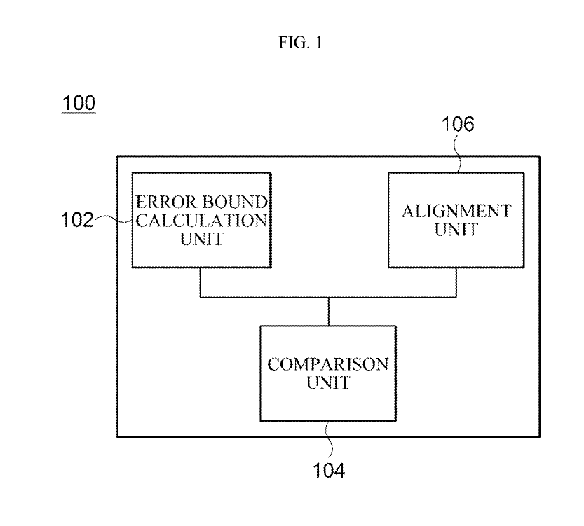

FIG. 1 is a block diagram showing a system 100 for aligning a genome sequence according to one exemplary embodiment of the present disclosure. As shown in FIG. 1, the system 100 for aligning a genome sequence according to one exemplary embodiment of the present disclosure includes an error bound calculation unit 102, a comparison unit 104, and an alignment unit 106.

The error bound calculation unit 102 receives a read from a sequencer, and calculates an error bound of the input read according to the length of the read.

The comparison unit 104 calculates an error number estimate of the input read, and compares the error bound calculated at the error bound calculation unit 102 with the calculated error number estimate.

The alignment unit 106 performs a global alignment of the read, in which the comparison result at the comparison unit 104 shows that the error number estimate is less than or equal to the error bound of the read, with the reference sequence.

Hereinafter, a configuration of the system 100 for aligning a genome sequence according to one exemplary embodiment of the present disclosure configured thus will be described in detail.

Calculation of Error Bound

As described above, the error bound calculation unit 102 calculates an error bound (MaxError) of the read according to the length of the read input from the sequencer, and the like. In this case, the error bound refers to the maximum value of error which may be present in the corresponding read. According to an exemplary embodiment of the present disclosure, the error bound may be set to be in proportion to the length of the input read. That is, as the length of the read increases, the probability of the read including errors becomes higher due to sequencing errors, polymorphisms in genetic information, etc. Therefore, when the error bound is equally applied regardless of the lengths of the reads, the reads having highly long lengths may be exempted from analysis of a genome sequence. Therefore, according to an exemplary embodiment of the present disclosure, an optimized error bound is configured to be applicable to the read by variably applying the error bound according to the lengths of the input reads.

According to one exemplary embodiment, the error bound may be calculated by the following Expression 1.

0<Error bound≦ceil(A×R_{length}+B)+K [Expression 1]

wherein R_{length} represents a length of a read, A is a real number ranging from 0.02 to 0.05, B is a real number ranging from 2.2 to 2.6, K is a real number ranging from 0 to 2, and ceil (X) is the least one of integers greater than or equal to X.

For example, it is assumed that A is set to be 0.037, B is set to be 2.399, and K is set to be 2, the error bound of a read having a length of 100 bp becomes ceil (0.037×100+2.399)+2=9.

Calculation of Error Number Estimate

Next, a procedure of calculating an error number estimate at the comparison unit 104 will be described. According to an exemplary embodiment of the present disclosure, an estimation of the number of errors may be achieved by calculating the minimum value of error (mEB; minimum Error Bound) which may occur when the read is aligned to the reference sequence. More particularly, the comparison unit 104 may perform exact matching of the read with the reference sequence while moving from the first base of the read by one base. In this case, when the exact matching is difficult at a certain position of the read (i.e., exact matching cannot be performed), the comparison unit 104 may be configured to newly perform the exact matching while moving from the next base of the corresponding position by one base. When the last base of the read is reached in this way, the comparison unit 104 may set the number of the positions that the exact matching is determined to be difficult during the movement procedure, as an error number estimate of the read.

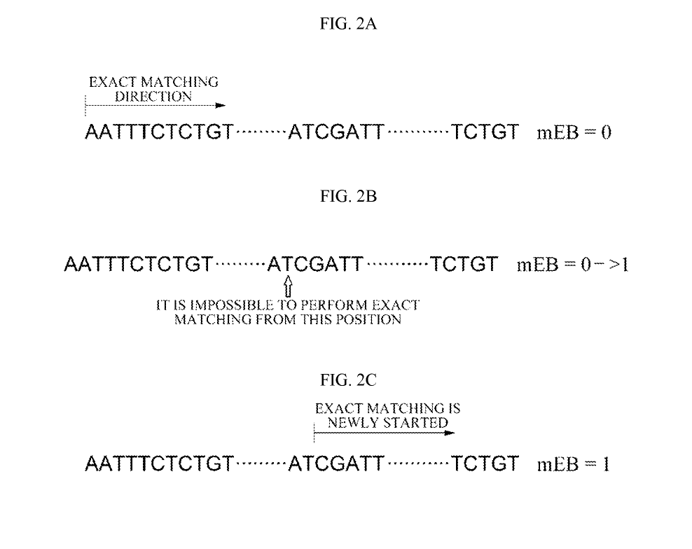

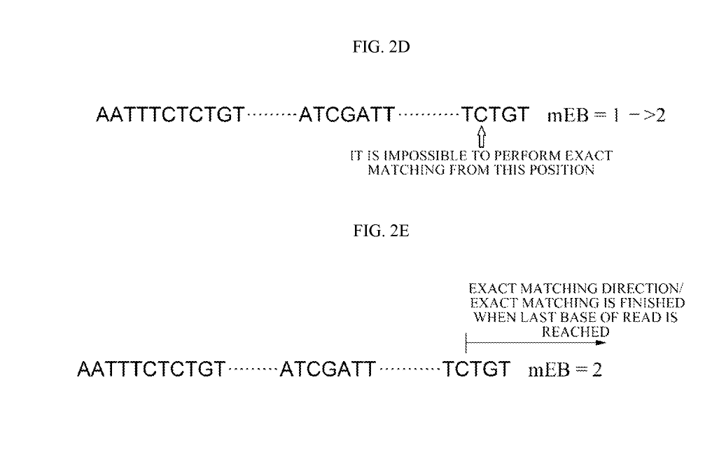

FIG. 2 is a diagram illustrating a process of calculating an mEB at a comparison unit 104. As shown in FIG. 2A, first, an original mEB is set as 0, and the exact matching is attempted while the comparison unit 104 is moving from the first base of a read toward the last base of the read by at least one base (moving by one base according to this exemplary embodiment). In this case, as shown in FIG. 2B, when it is assumed that it is impossible to perform the exact matching from a certain base (indicated by an arrow in the drawing) of the read, an error occurs in any one base of the read between a matching start position and a present position. In this case, the mEB increases by 1, and the exact matching is newly started at the next position (shown in FIG. 2C). Thereafter, when it is judged that it is impossible to perform the exact matching at another certain position for the second time, another error occurs in any one base of the read between a position in which the exact matching is newly started and a present position. Therefore, the mEB increase again by 1, and the exact matching is newly started at the next position (shown in FIG. 2D). When the last base of the read is reached through this procedure, the mEB becomes the minimum value for the number of errors which may occur in the corresponding read.

Comparison of Error Bound (MaxError) and Error Number Estimate (mEB)

When the error bound (MaxError) and the error number estimate (mEB) are calculated through such a procedure, then, the comparison unit 104 compares the error bound with the calculated error number estimate. When the comparison result shows that the error number estimate is greater than the error bound (mEB>MaxError), the comparison unit 104 judges that the corresponding read is not a target to be aligned any more, and discards the corresponding read.

On the other hand, when the comparison result shows that the error number estimate is less than or equal to the error bound (mEB≦MaxError), the comparison unit 104 requests an alignment of the corresponding read to the alignment unit 106, and the alignment unit 106 performs a global alignment of the corresponding read with the reference sequence.

According to an exemplary embodiment of the present disclosure, a method of aligning a read at the alignment unit 106 is not particularly limited. For example, methods known in the related art to which the present disclosure belongs may be used without limitation. According to one exemplary embodiment, the alignment unit 106 may align a read with the reference sequence by producing one or more seeds from one read, mapping the produced seeds to the reference sequence, and performing global alignments of the other bases of the read in mapping positions of the seeds. In addition, the alignment unit 106 may align the read with the reference sequence using various algorisms in consideration of properties of the read, and the like.

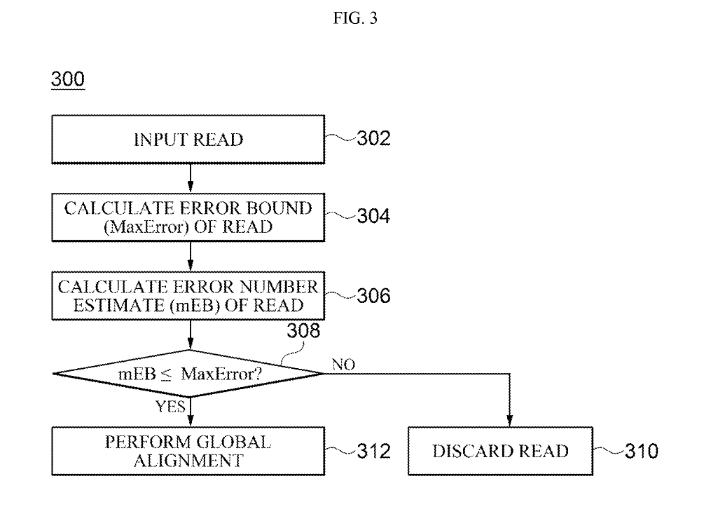

FIG. 3 is a flowchart illustrating a method 300 of aligning a genome sequence according to one exemplary embodiment of the present disclosure.

When a read is input from a sequencer (302), first, the error bound calculation unit 102 calculates an error bound (MaxError) of the read according to the length of the input read (304). As described above, the error bound may be set to be in proportion to the length of the read. For example, the error bound may be calculated using the above-described Expression 1.

Meanwhile, although not shown in FIG. 3, prior to the calculating of the error bound (304), the method may further include attempting exact matching of the corresponding read with the reference sequence. In this case, when the read exactly matches the reference sequence, the alignment of the corresponding read may be judged to succeed directly without undergoing the subsequent procedures.

When the error bound is calculated, the comparison unit 104 then calculates an error number estimate (mEB) of the read (306). A specific procedure of calculating the error number estimate is as described above.

Next, the comparison unit 104 compares the error bound (MaxError) with the calculated error number estimate (mEB) (308). When the comparison result in operation 308 shows that the error number estimate is greater than the error bound (mEB>MaxError), the comparison unit 104 judges that the corresponding read is not a target to be aligned any more, and discards the corresponding read (310). On the other hand, however, when the comparison result shows that the error number estimate is less than or equal to the error bound (mEB≦MaxError), the alignment unit 106 performs a global alignment of the corresponding read with the reference sequence (312).

Meanwhile, according to exemplary embodiments of the present disclosure, the system may include a computer-readable recording medium including programs executing the method as described herein above on a computer system having one or more hardware processors. The computer-readable recording medium may include program commands, local data files, local data structures, and the like, which may be used alone or in combination. The medium may be specially designed and configured for the present disclosure, or may include those known and available to those skilled in the field of computer software. Examples of the computer-readable recording medium include magnetic media such as a hard disk, a floppy disk, and a magnetic tape, optical recording media such as a CD-ROM and a DVD, magneto-optical media such as a floppy disc, and hardware devices such as a ROM, a RAM, and a flash memory, which are especially configured to store and perform the program commands. Examples of the program commands may include high-level language codes executable by a computer using an interpreter, etc. as well as machine language codes made by compilers.

As described above, the system and method according to the exemplary embodiments of the present disclosure can be useful in maintaining accuracy in analysis of the genome sequence regardless of the properties of the reads calculated and output in a sequencer by applying the optimum error bound for each read according to the properties of the reads input from the sequencer. Accordingly, the system and method according to the exemplary embodiments of the present disclosure can be useful in analyzing all kinds of reads output from various sequencers regardless of the kinds of sequencers.

Although the present disclosure has been described through a certain embodiment, it shall be appreciated that various permutations and modifications of the described embodiment are possible by those skilled in the art to which the present disclosure pertains without departing from the scope the present disclosure.

Therefore, the scope of the present disclosure shall not be defined by the described embodiment but shall be defined by the appended claims and their equivalents.

What is claimed is:

1. A system for aligning a genome sequence, comprising:
an error bound calculation unit configured to calculate an error bound, of a read, according to a length of the read;
a comparison unit configured to calculate an error number estimate of the read and to compare the error bound with the calculated error number estimate to provide a comparison result; and
an alignment unit configured to perform a global alignment operation of the read with a reference sequence when the comparison result indicates that the calculated error number estimate is less than or equal to the error bound;
wherein at least one of the error bound calculation unit, the comparison unit, and the alignment unit is implemented using a hardware processor.

2. The system of claim 1, wherein the error bound calculation unit is further configured to set the error bound in proportion to the length of the read.

3. The system of claim 2, wherein the error bound calculation unit is further configured to calculate the error bound according to the following Expression:
0<Error bound≦ceil(A×R_{length}+B)+K
where:
R_{length} represents a length of a read,
A is a real number ranging from 0.02 to 0.05, inclusive,
B is a real number ranging from 2.2 to 2.6, inclusive,
K is a real number ranging from 0 to 2, inclusive, and
ceil (X) is the least one of integers greater than or equal to X.

4. The system of claim 1, wherein:
the comparison unit is further configured to perform exact matching of the read with the reference sequence while moving from a first base of the read by at least one base;
the comparison unit is further configured to detect when the comparison unit cannot perform the exact matching at a certain position of the read, and to respond to the detection by newly performing the exact matching while moving from a next base of the corresponding position by at least one base; and
the comparison unit is further configured to determine when a last base of the read is reached, and to set a number of the positions, at which the exact matching could not be performed, as an error number estimate of the read.

5. The system of claim 1, wherein the comparison unit is further configured to discard the read when the comparison result shows that the calculated error number estimate is greater than the error bound.

6. A method for aligning a genome sequence, comprising:
calculating an error bound, of a read, according to a length of the read, using a calculation unit;
calculating an error number estimate of the read using a comparison unit;
with the comparison unit, comparing the error bound with the calculated error number estimate to provide a comparison result; and
performing a global alignment operation of the read with a reference sequence, with an alignment unit, when the comparison result indicates that the calculated error number estimate is less than or equal to the error bound;
wherein at least one of the error bound calculation unit, the comparison unit, and the alignment unit is implemented using a hardware processor.

7. The method of claim 6, further comprising setting the error bound of the error bound calculation unit in proportion to the length of the read.

8. The method of claim 7, further comprising calculating the error bound according to the following Expression:
0<Error bound≦ceil(A×R_{length}+B)+K
where:
R_{length} represents a length of a read,
A is a real number ranging from 0.02 to 0.05, inclusive,
B is a real number ranging from 2.2 to 2.6, inclusive,
K is a real number ranging from 0 to 2, inclusive, and
ceil (X) is the least one of integers greater than or equal to X.

9. The method of claim 6, wherein:
the calculating of the error number estimate comprises performing exact matching of the read with the reference sequence while moving from a first base of the read by at least one base;
when the exact matching cannot be performed at a certain position of the read, newly performing the exact matching from a next base of the corresponding position by at least one base; and
when a last base of the read is reached, setting a number of the positions, at which the exact matching could not be performed, as an error number estimate of the read.

10. The method of claim 6, wherein the comparing of the error bound with the calculated error number estimate further comprises discarding the read when the comparison result shows that the calculated error number estimate is greater than the error bound.
